(19) United States
(12) Patent Application Publication
(10) Pub. No.: US 2005/0220135 A1
(43) Pub. Date: Oct. 6, 2005

(54) Wireless communication method and wireless communication device

(75) Inventors: Yuji Honda, Minato-ku (JP); Shigeru Amano, Minato-ku (JP)

Correspondence Address: SHINJYU GLOBAL IP COUNSELORS, LLP, 1233 20TH STREET, NW, SUITE 700, WASHINGTON, DC, 20036-2680, US

(73) Assignee: Oki Electric Co., Ltd., Minato-ku (JP)

(21) Appl. No.: 10/941,833

(22) Filed: Sep. 16, 2004

(30) Foreign Application Priority Data
Apr. 6, 2004 (JP) JP 2004-112467

(51) Int. Cl. H04B 1/69

(52) U.S. Cl. 370/437; 375/132

(57) ABSTRACT

A wireless communication device control method employing Adaptive Frequency Hopping that switches among a plurality of channels except for a channel subject to interference by interfering waves includes creating, setting, processing reception, restricting use and resetting use restriction. In the creating step, a hopping pattern is created by using available channels. In the setting step, channels used for the communication are set based on the hopping pattern. In the processing reception step, received signals on the channels are processed. In the restricting use step, use of the interfered carrier channel is restricted when interfering waves are detected in the channel after detection whether interfering waves exist. In the resetting use restriction step, the restriction on use of the restricted channel is reset when interfering waves are not detected in the channel by carrier-sensing in the channel during idle time where the wireless communication device does not perform communication.

### BACKGROUND OF THE INVENTION

1. Field of the Invention

The present invention relates to a wireless communication control method and a wireless communication device. More specifically, the present invention relates to a wireless communication control method for a wireless communication device employing Adaptive Frequency Hopping that switches among a plurality of channels except a channel subject to interference by interfering waves in a predetermined frequency band for communication and a wireless communication device thereof.

### BACKGROUND INFORMATION

BLUETOOTH™ employs a frequency hopping method providing 79 channels, each with 1 MHz bandwidth, in the 2.4 GHz band (ISM: Industry Science Medical Band). The frequency hopping method also switches these channels at a rate of 1600 times per second. In the 2.4 GHz band (ISM band), since radio waves from other devices such as wireless LANs and microwave ovens coexist additionally with radio waves of the BLUETOOTH™ communications system, the radio waves from other devices may interfere as interfering waves with the radio waves of the BLUETOOTH™. In order to reduce mutual interference between the radio waves of the BLUETOOTH™ and other devices, BLUETOOTH™ ver 1.2 employs Adaptive Frequency Hopping (AFH) that performs frequency hopping by using channels, which do not interfere with the radio waves from other devices and are restricted to channels that do not suffer from interference.

Japanese Laid-open Patent Publication TOKUKAI No. JP2003-234745, especially pages 3-5 and FIGS. 1-5 and 12 thereof, shows a compound radio equipment having a wireless LAN device, a device using the BLUETOOTH™, and a wireless control device. With this type of compound radio equipment, before the wireless LAN device and the device using the BLUETOOTH™ communicate with other wireless devices, the wireless control device respectively allocates available channels to the wireless LAN device and the device using the BLUETOOTH™. Further, the wireless LAN device and the device using the BLUETOOTH™ communicate with other wireless devices by using the allocated channels. Thus, the mutual interference is reduced. JP2003-234745 is hereby incorporated by reference.

With the foregoing Adaptive Frequency Hopping, if interfering waves from other devices exist in a channel of the set channels, the channel is restricted from use. However, since the channel, which has been already restricted from use once, is not used as the carrier channel, it is impossible to detect whether an error in received data occurs in the channel. For this reason, with the conventional AFH, even if the interfering waves disappears in the channel restricted from use, it is impossible to determine whether the restriction on the channel can be reset. Accordingly, the restriction on the use of the channel is maintained. As a result, the number of available channels for communication decreases. Thus, deterioration in the spreading factor of transmitted signal results. For example, in the case that one wireless LAN device performs communication in the periphery of a BLUETOOTH™ communication device, 20 channels of the 79 channels used for the BLUETOOTH™ communication mutually interferes with the wireless LAN device, and thus, the 20 channels are restricted from use. Consequently, spread coding is performed by using 59 channels, and the spreading factor of the transmitted signal deteriorates when compared with the 79 channels where interfering waves do not exist.

Furthermore, with the compound radio equipment shown in JP2003-234745, though interference between the wireless LAN device and the device using the BLUETOOTH™ installed therein can be reduced by allocating channels to avoid mutual interference in the communication, JP2003-234745 does not describe how mutual interference with other devices is reduced when the other devices emitting interfering waves exit in the periphery of the compound radio equipment. Moreover, JP2003-234745 does not address deterioration of the spreading factor in the Adaptive Frequency Hopping.

In view of the above, it will be apparent to those skilled in the art from this disclosure that there exists a need for an improved wireless communication method and wireless communication device. This invention addresses this need in the art as well as other needs, which will become apparent to those skilled in the art from this disclosure.

### SUMMARY OF THE INVENTION

A wireless communication control method of the present invention for a wireless communication device employing Adaptive Frequency Hopping that switches among a plurality of channels except a channel subject to interference by interfering waves in a predetermined frequency band for communication includes steps of creating, setting, processing reception, restricting use, and resetting use restriction.

In the creating step, a hopping pattern is created by using available channels. In the setting step, channels used for the communication are set based on the hopping pattern. In the processing reception step, received signals on the channels are processed. In the restricting use step, use of the interfered carrier channel is restricted when interfering waves are detected in the channel after detection of whether interfering waves exist. In the resetting use restriction step, the restriction on use of the channel, which has been already restricted from used once, is reset when interfering waves are not detected in the channel by carrier-sensing in the channel restricted from use during idle time when the wireless communication device does not perform communication.

With this wireless communication control method, mutual interference between radio waves for communication and interfering waves is avoided by restricting use of a channel in which interfering waves exist, and the restriction on the use of the channel, which has been already restricted from use once, is reset when interfering waves do not exist in the channel by carrier-sensing in the channel restricted from use during idle time when the communication is not performed. Thus, use of the channel, in which interfering waves do not exist, can be quickly reset for use, and it is possible to make the most of the channel, in which interfering waves do not exist, and to perform spread spectrum coding on a transmission signal. Therefore, deterioration of spreading factor can be kept in check.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a view of a schematic diagram showing a wireless communication system in accordance with a preferred embodiment of the present invention;

FIG. 2 is a view of a schematic diagram showing a master the wireless communication system;

FIG. 3 is a view of a timing chart of transmission/reception of data between the master and a slave of the wireless communication system;

FIG. 4 is a view of a timing chart of transmission/reception of data between the master and the slave in a sniff mode;

FIG. 5 is a view of a timing chart of transmission/reception of data between the master and the slave in a hold mode;

FIG. 6 is a view of a timing chart of transmission/reception of data between the master and the slave in a park mode; and

FIG. 7 is a view of a flow chart of transmission/reception of data in the master.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### Embodiment 1

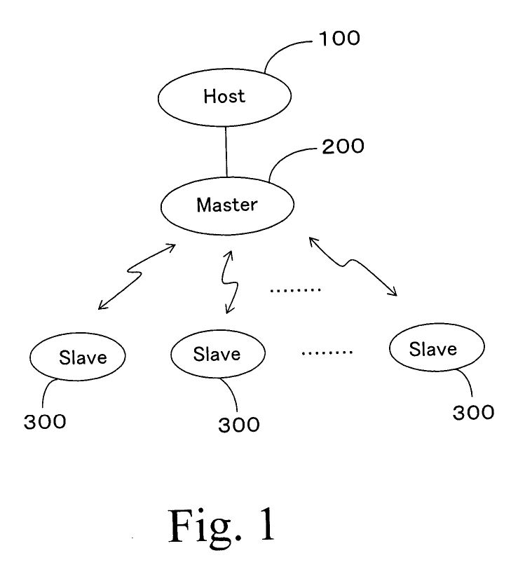

FIG. 1 is a schematic view of a wireless communications system employing BLUETOOTH™ communication method with Adaptive Frequency Hopping in accordance with a preferred embodiment of the present invention. This BLUETOOTH™ communication system includes a host 100, a master 200, and a plurality of slaves 300a-300g.

The host 100 is a device that controls communication between the master 200 and the plurality of slaves 300a-300g. The host 100 is composed of a personal computer (PC) and connected to the master 200 via a UART cable or the like. In the case that the master 200 is installed in a small device such as a mobile phone, the host 100 may be a program to control the BLUETOOTH™ communication among the master 200 and the plurality of slaves 300a-300g. The master 200 is a wireless communication device that communicates with slaves 300a-300g based on control from the host 100. The slaves 300a-300g are wireless communication devices that communicate with the masters 200 based on control from the master 200.

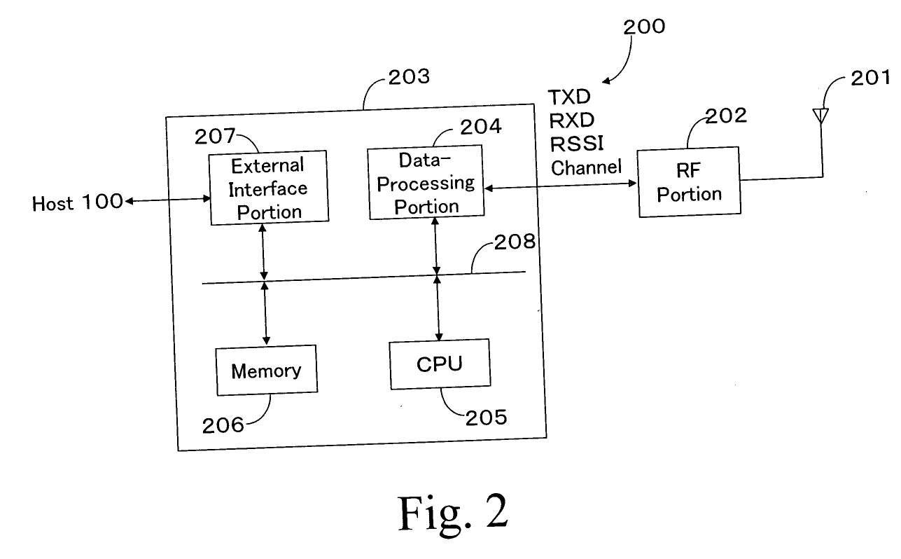

FIG. 2 is a schematic diagram showing the master 200. The master 200 includes an antenna 201, an RF portion 202, and a baseband portion 203. The RF portion 202 converts an RF signal (receive signal) of radio waves received by the antenna 201 into receive data RXD, which are a digital signal, in a channel set by a data-processing portion 204 described later. The RF portion 202 converts transmission data TXD, which are a digital signal, into the RF signal (transmission signal) and provides it as radio waves through the antenna 201 in the channel set by the data-processing portion 204. In addition, the RF portion 202 measures RSSI (Receive Signal Strength Indicator) of the receive signal, and provides RSSI data, which are converted from a measured value, to the baseband portion 203.

The baseband portion 203 includes the data-processing portion 204, a CPU 205, a memory 206, and an external interface portion 207. The data-processing portion 204, the CPU 205, the memory 206, and the external interface portion 207 are connected to each other through a bus 208. The external interface portion 207 is connected to the host 100, and interfaces with the host 100. The data-processing portion 204 processes the receive data RXD based on control from the CPU 205. In addition, the data-processing portion 204 creates the transmission data TXD and provides it to the RF portion 202 based on control from the CPU 205. The data-processing portion 204 includes a register, and temporarily records the RSSI data received from the RF portion 202 and available channels received from the CPU 205. Additionally, the data-processing portion 204 creates a hopping pattern containing switching order for the channels, and provides a transmission/reception channel (carrier channel) to the RF portion 202. The CPU 205 controls the data-processing portion 204 based on communication with the host 100 through the external interface portion 207. The memory 206 stores a main program such as a communication protocol program performed by the CPU 205, a use restriction file specifying a channel restricted from use, a processing result in the CPU 205, and so on. The memory 206 is composed of a nonvolatile memory such as a flash memory and a mask ROM, and a volatile memory such as RAM, for example.

The above description describes construction of the master 200. Construction of each of the slaves 300a-g is similar to the master 200, thus their description is omitted. With the slaves 300 a-g, the memory 206 stores a use availability file, which specifies the available channels, instead of the use restriction file.

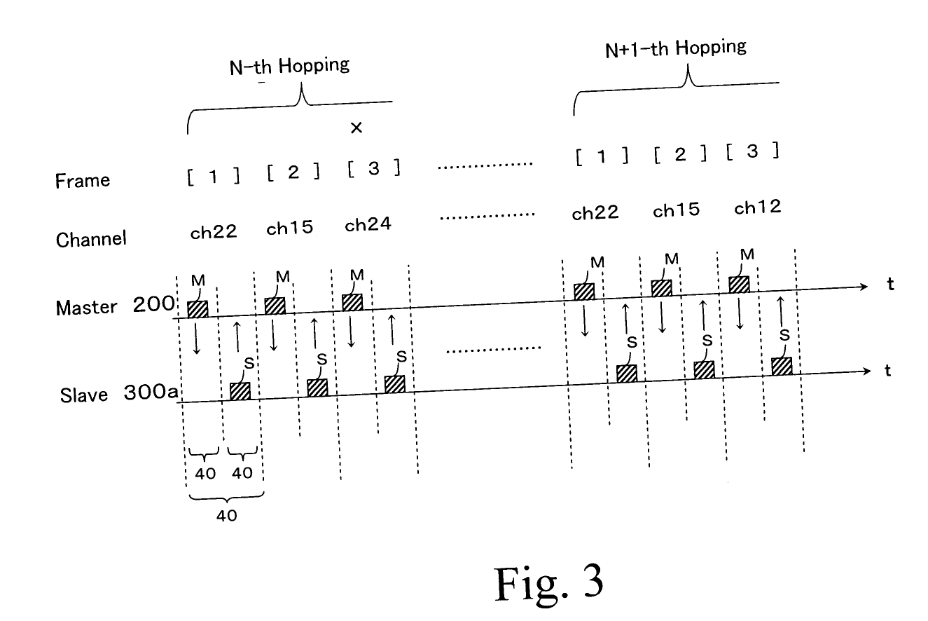

FIG. 3 is a timing chart of communication performed between the master 200 and a slave 300a. Hereafter, though the following description will describe communication between the master 200 and the slave 300a as one example, communication between the master 200 and other slaves is similar to it.

A frame 400 represents a frame used as a unit for transmission/reception of data in BLUETOOTH™ communication. The frame 400 includes a slot 401 and a slot 402. The slot 401 is allocated for data transmission from the master 200 to slave 300a. The slot 402 is allocated for data transmission from the slave 300a to the master 200. M represents transmission data TXD transmitted from the master 200 to the slave 300a. S represents transmission data TXD transmitted from slave 300a to the master 200.

With Adaptive Frequency Hopping, if there are other devices emitting interfering waves such as a wireless LAN and/or a microwave oven in the periphery of the wireless system, and interfering waves exist in a channel of the channels set as the carrier channels used for data transmission/reception, the channel is restricted from use. Specifically, the master 200 determines the interference based on RSSI of the radio waves from the slave 300a, and the occurrence of error in the received data RXD from the slave 300a. When the RSSI of the radio waves from the slave 300a is low, there is a possibility that the error of the received data RXD is caused by the small intensity radio waves from the slave 300a. For this reason, in the case that a value of the RSSI of the radio waves from the slave 300a is not less than a predetermined value, when an error occurs in the received data RXD, it is determined that the error occurred in the received data RXD by interfering waves. In other words, when the predetermined value satisfies the intensity that allows communication to be preferably performed under the condition where interfering waves do not exist, it is determined that interfering waves cause the error in the received data RXD. The predetermined value for determination of the intensity of the RSSI of the radio waves from the slave 300a is set by previously measuring the value of RSSI that allows communication between the master 200 and the slave 300a to be preferably performed under the environment where other devices emitting interfering do not exist in the periphery, thus, the interference from the slave 300a can be considered.

The determination is made by the hardware construction of FIG. 2 as follows. The RF portion 202 measures the intensity of RSSI of radio waves from the slave 300a, and provides the RSSI data to the data-processing portion 204. The data processing portion 204 stores the RSSI data in the resister. The CPU 205 acquires the RSSI data stored in the resister, and determines whether the RSSI data are less than a predetermined value. Furthermore, the CPU 205 determines whether an error occurs in the received data processed by the data processing portion 204. The CPU 305 determines that mutual interference caused by interfering waves exist when the RSSI data are not less than the predetermined value and an error occurs in the receive data.

The example of FIG. 3 shows the case where mutual interference caused by interfering waves exists (in the case that RSSI is not less than the predetermined value and an error occurs in the receive data RXD) when a channel ch24 is set in a frame [3] of n-th hopping pattern. In the case that the ch24 is set in the frame [3], if it is determined that RSSI is not less than the predetermined value and an error occurs in the receive data RXD, the CPU 205 writes the channel ch24 in the use restriction file of the memory 206, and creates available channel information based on the recorded contents of the use restriction file. Further, the available channel information and timing information (hereinafter referred to as AFH setting information), which switches the hopping pattern sequence, are provided from the master 200 to the slave 300a. The slave 300a, which receives the AFH setting information, writes the information on available channels in the use availability file of the memory 206. The CPUs 205 of the master 200 and the slave 300a record the use restriction file or use availability file of the memory 206 in the register of the data control portion 204 with switching timing of hopping pattern sequence. After this timing, the data-processing portions 204 of the master 200 and the slave 300a create a hopping pattern by using channels with the exception of the unavailable channel, in this case ch24. In the example of FIG. 3, the ch12 is set as a channel of the frame [3] in an n+1st hopping pattern instead of the ch24. In this case, the ch12 is the available channel.

As mentioned above, with Adaptive Frequency Hopping, a plurality of channels in the predetermined band is switched in a random fashion to perform communication, and the channel restricted from use caused by interfering waves is replaced with an available channel at the sequence corresponding to the restricted channel. However, when use restriction is maintained even after the interfering waves do not exist, the number of available channels gradually decreases, and thus, the spreading factor in spread coding deteriorates. Accordingly, in this embodiment, in order to prevent deterioration of spreading factor, the restriction on use of a channel, which has been restricted from use once, is reset when interfering waves do not exist in the channel by carrier-sensing in the channel restricted from use during idle communication times. On the other hand, when existence of interfering waves is detected by carrier-sensing, the use restriction of the channel is maintained.

Determination of existence of interfering waves is made by measuring RSSI of interfering waves. That is, during idle communication times, the RF portion 202 of the master 200 measures RSSI of interfering waves, and the RSSI data are provided to the data-processing portion 204, and the data-processing portion 204 records the RSSI data of interfering waves in the register. The CPU 205 acquires the RSSI of interfering waves, and determines whether the RSSI of interfering waves is less than the predetermined value. When the RSSI of interfering waves is not less than the predetermined value, the CPU 205 determines that interfering waves still exist in the carrier-sensed channel, and maintains the use restriction on the carrier-sensed channel. On the other hand, when the RSSI of interfering waves is waves is less than the predetermined value, it is determined that interfering waves do not exist in the carrier-sensed channel, the channel recorded in the use restriction file of the memory 206 is deleted, and the use restriction on the carrier-sensed channel is reset to remove the restriction.

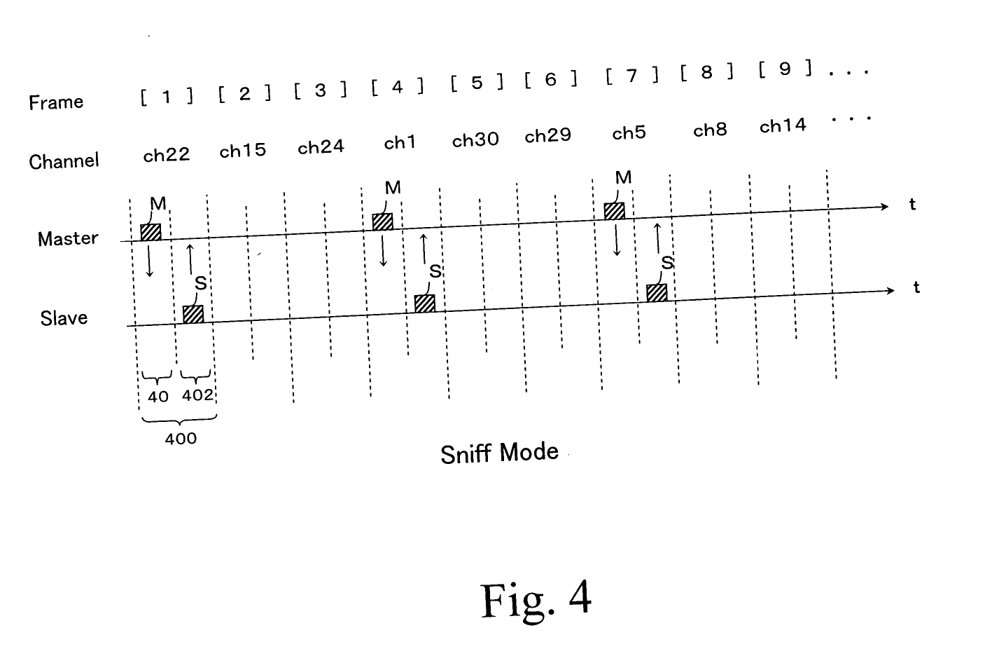

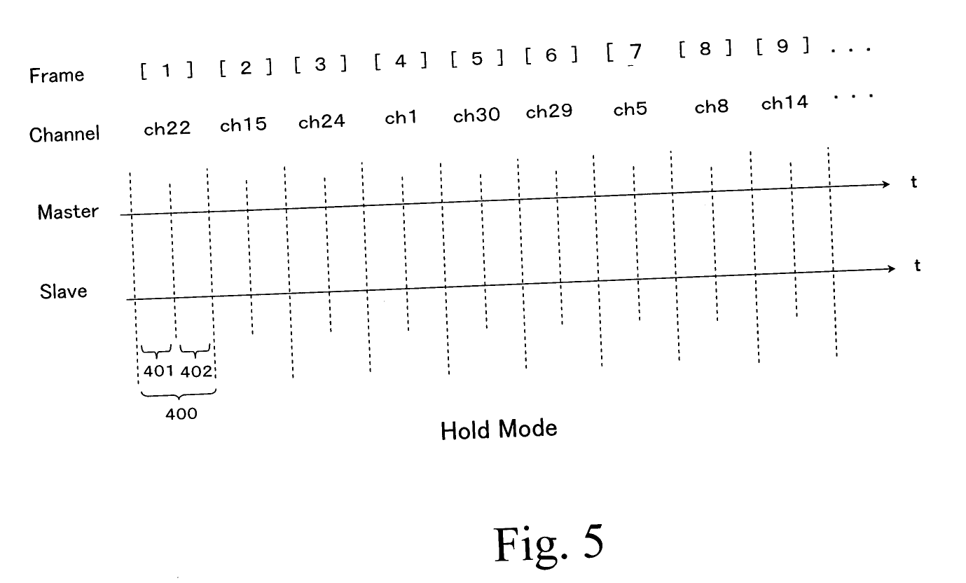

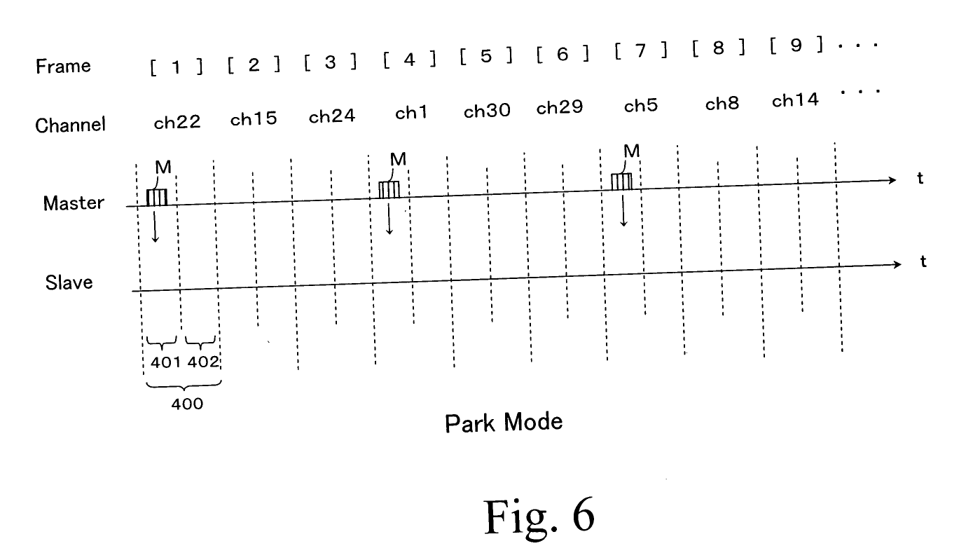

The idle communication time is a period of a frame where the master device 200 does not transmit data to the slave 300a, or a period where the master device does not transmit/receive data in a low power consumption mode such as a hold mode, a sniff mode, and a park mode. As seen in FIG. 5, the hold mode is a mode in which the master 200 waits without transmitting data to the slave 300a. The sniff mode is a mode where a predetermined number of slots, in which communication is not performed, exist between frames, in which data are transmitted/received, as shown in FIG. 4. In the example of FIG. 4, data are not transmitted/received in second and third frames, fifth and sixth frames and eighth and ninth frames. These frames are idle times of communication. As seen in FIG. 6, the park mode is a mode in which the master 200 transmits only synchronization information on communication to the slaves 300a-g. Data are not transmitted/received in slots of the aforementioned frames except the slot 401, in which the master 200 transmits the synchronization information, in other words, in the slot 402 in which the slave 300a transmits data to the master. The slot 402 is an idle time of communication.

### Flowchart

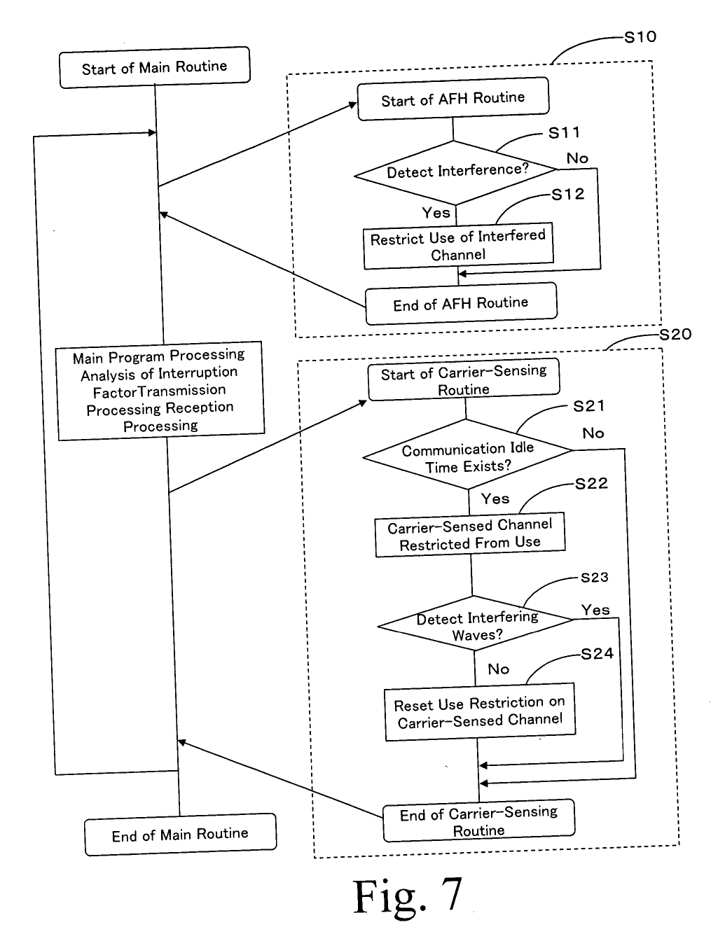

FIG. 7 is a view of a flow chart of communication process in the master 200. In main program processing, an interruption factor generated based on result of the transmission data TXD and the receiving data RXD processed by the data-processing portion 204 is analyzed, and processing is distributed.

In addition, Adaptive Frequency Hopping (AFH) processing branched from the main program processing is performed (step S10).

In step S11, it is determined whether mutual interference caused by interfering waves exists in a currently-set channel chX. As for the determination whether mutual interference caused by interfering waves exists, when RSSI of radio waves from the slave 300a is not less than the predetermined value and an error occurs in the receive data RXD from the slave 300a, it is determined that interfering waves exist in the channel chX, in the other cases, it is determined that interfering waves do not exist in the channel chX, as mentioned above. When it is determined that interfering waves exist in the channel chX, the CPU 205 goes to step S12, and records the channel chX in the use restriction file, and thus restricts use of the channel chX. On the other hand, when it is determined that interfering waves do not exist in the channel chX, the CPU 205 ends an AFH routine without restricting use of the channel chX.

In addition, a carrier-sensing routine branched from the main program processing is performed (step S20). In step S21, the CPU 205 determines whether idle time, in which communication is not performed, exists. The determination of idle time is made based on whether a frame, in which the master 200 does not transmit data, exists, and whether a current mode is a low power consumption mode such as a hold mode, a sniff mode, and a park mode. When idle time of communication does not exist (in the case of “No” in step S21), the CPU 205 does not perform carrier-sensing, and ends the carrier-sensing routine. When idle time of communication exists (in the case of “Yes” in step S21), the CPU 205 performs carrier-sensing in a channel restricted from use in the idle time of communication (step S22), and determines whether interfering waves exist in the carrier-sensed channel (step S23). Specifically, the channels recorded in the use restriction file of the memory 6 are sequentially read and set in the RF portion 202 in the idle time of communication, and it is determined whether RSSI of interfering waves is less than the predetermined value in the channels. When the interfering waves are not detected (i.e., the RSSI of interfering waves is less than the predetermined value), the CPU 205 deletes the carrier-sensed channel from the channels restricted from use, and resets the use restriction of the carrier-sensed channel (step S24). On the other hand, when the interfering waves are detected (RSSI of interfering waves is not less than the predetermined value), the CPU 205 ends the carrier-sensing routine without resetting or removing the use restriction of the carrier-sensed channel.

According to the wireless communication system of the present invention, when interfering waves exist in the periphery of the wireless communication system, mutual interference is reduced by restricting a channel from use, in which interfering waves exist, and carrier-sensing is performed on the channel restricted from use during idle communication times. If interfering waves are not detected in the carrier-sensed channel, use of restriction on the carrier-sensed channel is reset or removed. Thus, restriction use on a channel, which has been already restricted from use once, can be reset at any time after restriction. Therefore, it is possible to make the most of the channel, in which mutual interference caused by interfering waves do not exist. As the result, both reduction of mutual interference and improvement of spreading factor of spread spectrum coding can be obtained in Adaptive Frequency Hopping.

As used herein, the following directional terms “forward, rearward, above, downward, vertical, horizontal, below, and transverse” as well as any other similar directional terms refer to those directions of a device equipped with the present invention. Accordingly, these terms, as utilized to describe the present invention should be interpreted relative to a device equipped with the present invention.

### Alternate Embodiments

Alternate embodiments will now be explained. In view of the similarity between the first and alternate embodiments, the parts of the alternate embodiments that are identical to the parts of the first embodiment will be given the same reference numerals as the parts of the first embodiment. Moreover, the descriptions of the parts of the alternate embodiments that are identical to the parts of the first embodiment may be omitted for the sake of brevity.
(a) In the foregoing embodiment, the master 200 is described as one example, however, the slaves 300a-g may perform the carrier-sensing routine of FIG. 7. The slaves inform the master 200 of a channel, in which mutual interference caused by interfering waves do not exist, and thus recommend the master 200 to reset use restriction of the channel.
(b) In the foregoing embodiment, the AFH routine (step S10) is performed in parallel with the main program processing, however, the AFH routine may be performed during a wait time period such as a standby mode in order to obtain information on available channels prior to start of communication by the main program processing, in other words, prior to establishment of a link between the master and the slave. In this case, detection of interfering waves is not necessary after establishment of the link between the master and slave. Therefore, it is possible to more quickly avoid interfering waves, and to reduce mutual interference, and to improve transmission rate.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

This application claims priority to Japanese Patent Application No. 2004-112467. The entire disclosure of Japanese Patent Application No. 2004-112467 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. A wireless communication device control method comprising:
employing Adaptive Frequency Hopping being configured to switch among a plurality of channels except a channel subject to interference by interfering waves in a predetermined frequency band;
creating a hopping pattern using available channels;
setting channels used for the communication based on said hopping pattern;
processing received signals on said channels;
restricting use of an interfered carrier channel upon detection of interfering waves are detected in said interfered carrier channel; and
removing the restriction on use of said interfered carrier channel being previously restricted from use upon detection of absence of interfering waves in said interfered carrier channel by carrier-sensing in said interfered carrier channel restricted from use during idle time during an absence of communication in the wireless communication device.

2. The wireless communication device control method according to claim 1, wherein resetting the restriction on use of said interfered carrier channel is conducted when a value of a Received Signal Strength Indicator of interference waves measured in said interfered carrier channel restricted from use is less than a predetermined value.

3. The wireless communication device control method according to claim 1, wherein said idle time includes a period of a frame where said master device does not transmit data, and a period where said master device does not transmit or receive data in a low power consumption mode.

4. The wireless communication device control method according to claim 3, wherein said low power consumption mode is selected from the group consisting of a sniff mode, a hold mode, and a park mode.

5. The wireless communication control method according to claim 3, wherein, the wireless communication device is a master device performing communication employing a frequency hopping method providing 79 channels, each of said channels having 1 MHz bandwidth in the 2.4 GHz band, and switching said channels at a rate of 1600 times per second.

6. The wireless communication control method according to claim 1, wherein restricting use is executed previous to establishing of a communication link of the wireless communication device.

7. A wireless communication device comprising:
means for employing Adaptive Frequency Hopping configured to switch among a plurality of channels except a channel subject to interference by interfering waves in a predetermined frequency band;
means for creating a hopping pattern using available channels;
means for setting channels used for communication based on said hopping pattern;
means for processing received signals on said channels;
means for restricting use of an interfered carrier channel upon detection of interfering waves in said interfered carrier channel; and
means for resetting the restriction on use of said interfered carrier channel being previously restricted upon detection of absence of interfering waves in said interfered carrier channel by carrier-sensing in said interfered carrier channel restricted from use during idle time during an absence of communication in the wireless communication device.

8. The wireless communication device according to claim 7, wherein the means for restricting resets the restriction on use of said interfered carrier channel is conducted when a value of a Receive Signal Strength Indicator of interference waves measured in said interfered carrier channel restricted from use is less than a predetermined value.

9. The wireless communication device according to claim 7, wherein said idle time includes a period of a frame where said master device does not transmit data, and a period where said master device does not transmit or receive data in a low power consumption mode.

10. The wireless communication device according to claim 9, wherein said low power consumption mode is selected from the group consisting of a sniff mode, a hold mode, and a park mode.

11. The wireless communication device according to claim 9, wherein the wireless communication device is a master device performing communication employing a frequency hopping method providing 79 channels, each with 1 MHz bandwidth in the 2.4 GHz band, and switching said channels at a rate of 1600 times per second.

12. The wireless communication device according to claim 7, wherein the means for resetting detects whether interfering waves exist in a carrier channel previous to establishment of a communication link of the wireless communication device, and restricts use of said carrier channel when interfering waves exist in said carrier channel.

13. A wireless communication device comprising:
a CPU being configured to employ Adaptive Frequency Hopping to switch among a plurality of channels except a channel subject to interference by interfering waves in a predetermined frequency band for communication;
an RF circuit being configured to convert a received signal of a set channel to into received data;
a baseband circuit being configured to set channels in said RF circuit and to process said received data, said baseband circuit being configured to detect whether interfering waves exist in a channel, and to restricts use of an interfered carrier channel when interfering waves are detected in said interfered carrier channel, said baseband circuit being configured to remove the restriction on use of said interfered carrier channel being previously restricted when interfering waves are not detected in said interfered carrier channel by carrier-sensing in said interfered carrier channel during idle time during an absence of communication in the wireless communication device.

14. The wireless communication device according to claim 13, wherein said RF circuit measures a Receive Signal Strength Indicator value of interference waves in said interfered carrier channel restricted from use in said carrier-sensing, and said baseband portion resets the restriction on use of said interfered carrier channel, in which said carrier-sensing is performed when a Received Signal Strength Indicator value is less than a predetermined value.

15. The wireless communication device according to claim 13, wherein said idle time includes a period of a frame where said master device does not transmit data, and a period where said master device does not transmit or receive data in a low power consumption mode.

16. The wireless communication device according to claim 15, wherein said low power consumption mode consumption mode is selected from the group consisting of a hold mode, a sniff mode, and a park mode.

17. The wireless communication device according to claim 15, wherein the wireless communication device is a master device performing communication employing a frequency hopping method providing 79 channels, each with 1 MHz bandwidth in the 2.4 GHz band, and switching said channels at a rate of 1600 times per second.

18. The wireless communication device according to claim 13, wherein said baseband circuit detects whether interfering waves exist in a carrier channel previous to establishment of a communication link of the wireless communication device, and restricts use of said carrier channel when interfering waves exist in said carrier channel.
